(19) United States
(12) Patent Application Publication
(10) Pub. No.: US 2024/0083089 A1
(43) Pub. Date: Mar. 14, 2024

(54) APPARATUS AND METHOD FOR FORMING PLASTIC PREFORMS INTO PLASTIC CONTAINERS

(71) Applicant: KRONES AG, Neutraubling (DE)

(72) Inventors: Konrad SENN, Alteglofsheim (DE); Ulrich LAPPE, Neutraubling (DE); Bastian TISSMER, Regensburg (DE)

(21) Appl. No.: 18/243,949

(22) Filed: Sep. 8, 2023

(30) Foreign Application Priority Data
Sep. 8, 2022 (DE) 10 2022 122 887.8

(51) Int. Cl. B29C 49/42; B29C 49/48; B65D 1/02

(52) U.S. Cl. CPC B29C 49/427; B29C 49/4802; B65D 1/0223; B29L 2031/7158

(57) ABSTRACT

A plastic container having a mouth as well as a main body on an outer surface of the plastic container and/or through the outer surface of the plastic container itself using a wall material and in the form of a raised wall portion or a wall depression in the form of a wall structure. Container information is attached, wherein the container information on the finished plastic container replaces a label. The finished produced plastic container is free of a label, and at least one stiffening region is formed on an outer surface of the plastic container and/or is formed by a wall material of the container itself, in particular the stiffening region defines at least two regions on the outer surface which are separated from each other by the at least one stiffening region and the wall structures are distributed on at least these two regions.

### SUMMARY OF THE INVENTION

The present invention relates to a plastic container, a blow mold and a method for forming plastic preforms into plastic containers.

An apparatus and a method for forming plastic preforms into plastic containers have long been known from the prior art. Here, heated plastic preforms are usually supplied to forming stations and are formed into plastic containers within these forming stations, in particular by applying a gaseous or liquid medium. In this case, it is known from the prior art on the one hand to expand the plastic preforms by means of a gaseous medium and in particular compressed air, but recently it has also become known to expand the plastic preforms by means of a liquid, in particular by means of a beverage to be filled. The present invention is applicable for both procedures.

According to the invention, the plastic container described herein is one having a mouth as well as a main body, wherein, on an outer surface of the plastic container and/or through the outer surface of the plastic container itself, by means of a wall material and in the form of at least one raised wall portion or at least one wall depression in the form of a wall structure a container information is attached, so that the container information on the finished plastic container replaces a label information, in particular wherein the finished produced plastic container is free of a label, and has at least one stiffening region formed on an outer surface of the plastic container and/or formed by a wall material of the plastic container itself, in particular wherein the stiffening region defines at least two regions on the outer surface which are separated from each other by the at least one stiffening region and the wall structures are distributed over at least these two regions.

By dispensing with a label, a “no label” bottle is thus produced.

The stiffening region can for example be a material thickening or thinning of the wall thickness of the container, also preferably perceptible haptically by the human hand and/or human finger (wall grooves or planar wall thinning are also possible), which requires more stability for the entire wall structure of the container and at the same time ensures a savings of material. This is because in principle, stiffening regions are used in a container wall to reduce the remaining wall surface portion or wall volume portion. That is, the remaining points of the container wall are therefore made that much thinner.

In this respect, particularly lightweight containers can be produced which, however, have corresponding wall thickenings in the area of the negative image of the embossing area between the individual lettering elements.

Even assuming that no-label bottles were known in the prior art, these bottles would have a very large so-called “display surface” on which the information is applied. These have the disadvantage that large, spherical, in particular smooth surfaces do not always have the optimal static properties. Thus, such no-label bottles, under pressure load (i.e., top load, burst pressure, thermostability or bottom clearance) have poor stability.

Thus, a core feature of the invention is, among other things, to have a non-continuous display surface that can advantageously intermix with supporting elements (i.e., for example, ribs, material thickenings, and/or grooves with information surfaces). This makes it possible to produce light no-label bottles.

Corresponding stiffening elements can also occur or be arranged in the container wall away from the embossing section, i.e., outside the embossing section. A stiffening region therefore does not necessarily have to pass through an embossing section, for example in the vertical direction (parallel to the longitudinal axis of the container), but can also actually be arranged either on the container wall and/or also on the container bottom and/or in the neck area of the container.

According to at least one embodiment, the stiffening region in the finished plastic container is made in the form of at least one stiffening rib.

In the sense of the present invention, a stiffening rib can be an elongated element which is strip-shaped and forms a wall thickening or wall thinning, compared to the remaining wall thickness of the container, whereby not only a material saving is possible, but the stiffening regions itself are designed to be particularly stiff, so that as few stiffening regions as possible are required on or in the container wall in order to give the container sufficient stability. According to at least one embodiment, a wall thickness of the main body at a point of the largest container diameter is less than 0.15 mm and preferably at most 0.14 mm and at least 0.11 mm.

According to at least one embodiment, a minimum weight load limit of the partially filled plastic container along a longitudinal container axis is at least 20 kg and preferably at most 30 kg.

According to at least one embodiment, the container information is selected from a group of properties and/or information of the container. This group comprises good readability, minimum lettering size, designation of a food product in particular as a filling product, net fill quantity, best before date of the filling product, country of origin or place of origin (name of the company or address of the food company), allergy labeling, list of ingredients, quantitative indication of ingredients, storage and use conditions, alcohol content of the filling product and/or nutritional value declaration.

According to at least one embodiment, the stiffening element increase static properties of the plastic container, such as a longitudinal axis load (top load) and/or diameter load (side load).

According to at least one embodiment, the course of the stiffening element also follows force lines in the event of a force load on the plastic container and/or the stiffening element corresponds to or at least partially resembles organic shapes, such as ribs in dragonfly wings.

According to at least one embodiment, the plastic container was filled with nitrogen before being closed.

According to at least one embodiment, the invention described herein further relates to a method for forming plastic preforms into plastic containers, wherein at least one and preferably a plurality of forming stations for forming the plastic preforms into the plastic containers are arranged on a movable carrier, and said forming stations are moved along a predetermined transport path at least at times during the forming process, wherein the forming stations each have blow mold arrangements, wherein blow mold parts of these blow mold arrangements are moved to open and close the blow mold arrangements, and in a closed state of the blow mold arrangement in a cavity formed by the blow mold parts the plastic preforms are formed into the plastic containers by the application of a flowable medium.

According to at least one embodiment, at least one inner surface of the blow mold parts facing the plastic preform has at least one embossing section in the form of at least one surface raised part and/or one surface depression for forming at least one raised wall portion or at least one wall depression for forming a container information on the later finished container, so that the container information is a negative image of the embossing section, and/or a digital watermark is applied to the finished container, in particular as the container information. In this respect, the present invention proposes two alternative or complementary methods of applying a container information.

In any case, the container information is formed by the container wall itself. This includes the incorporation of a coding, such as the watermark. The digital watermark is a technology for concealing information which is useful, for example, in the steganographic coding of printed products in order to transmit multiple symbols as useful data. For example, printed graphics on the packaging of a retail product, such as the plastic containers described herein, can be provided with a digital watermark that contains the product's Global Trade Identification Number (GTIN) identifier. Known digital watermark methods are described in, inter alia, patent specifications U.S. Pat. Nos. 6,590,996 and 8,199,969.

According to at least one embodiment, a digital watermark is used to ensure that the finished containers that are to be combined with one another are correctly matched to one another. An example are container packs etc.

A watermarking system consists of two components: the embedder inserts the watermark information into the medium, for example into the container wall, and the detector can then read it out again. Each watermarking system has certain properties that depend on the watermark's area of application.

According to at least one embodiment, digital watermarks are used to reduce a growing type of retail fraud, namely the substitution of barcodes.

In a preferred embodiment, the movable carrier is a rotatable carrier. This means that the at least one forming station and preferably a plurality of forming stations are arranged on a rotatable carrier (also referred to as a blowing wheel). Thus, during a movement of the carrier, which is in particular a rotational movement, the forming stations and thus in particular also the plastic preforms to be expanded are moved along a circular and/or substantially circular path.

In a further preferred method the blow mold arrangement has two side parts which are pivoted with respect to one another for opening and closing the blow molds. Here a pivoting is preferably carried out about a vertical axis and/or about an axis which is arranged parallel to the plastic preform to be expanded.

Preferably, the blow mold arrangements also have a bottom part which, together with the two side parts, forms the stated cavity.

In a further advantageous embodiment, the forming stations (each) have rod-shaped bodies or stretching rods which can be inserted into the plastic preforms in order to expand them in the longitudinal direction thereof. Particularly preferably, a corresponding forming device is therefore a blow molding machine and in particular a stretch blow molding machine.

As mentioned above, the medium for expanding the plastic preforms can be a gaseous or also a liquid medium.

In the context of the invention, it has been recognized that plastic containers are usually provided with a label on which container information is shown. The container information can be, for example, the indication of a container size, a volume specification of the container, or other information about the beverage to be filled.

However, during a recycling process this label must first be removed from the container bottle, which is difficult. This recycling process is not only time-consuming but also burdened with certain costs.

Therefore, in order to make the entire manufacturing process more sustainable the inventors have come up with the idea that by preferably completely dispensing with labels, corresponding container information, for example label indications (printing on the labels), can also be applied directly to the outer wall of the container or can be formed by the outer wall itself.

Preferably, therefore, all labels are dispensed with so that the recycling process can do without this costly and sometimes lengthy process.

This saves not only material but also energy consumption for the overall recycling process.

An object of the present invention is therefore to provide, in a particularly simple and cost-effective manner, a method for producing containers in which a later recycling process of the containers omits a detaching of labels.

According to at least one embodiment, the method is characterized in that the container information on the finished plastic container replaces a label information and the container then finally produced is preferably free of a label. It would also be conceivable for part of the consumer information or other information to be attached or printed to the closure, such as a text, a QR code, etc.

According to at least one embodiment, during the forming process, the expanding plastic container is pressed against this inner surface by the flowable medium so that, as a result of this application of pressure, the embossing section leaves the container information on the outer surface of the plastic container as a negative image.

Therefore, during the stretch blow molding process, which is assumed as an example, the wall material of the expanding plastic preform is pressed against the wall and pressed into the recesses and/or against the raised parts on the inner surface of the side part, so that a negative pressure image results, namely on the outer surface of the plastic preform.

This negative printing image is therefore the container information described here.

According to at least one embodiment, the embossing section has debossed areas and/or embossed areas.

Such debossed and/or embossed areas can preferably also be stroked over with a smooth hand and felt haptically.

For example, the container information is covered with a color at least in places. This can be done using ink rollers rolled over the lettering of the container information. However, other color application methods are also possible. In such a method, only the debossed areas of the container are given a color, making them more readable. The ink can in particular be ink that can be crosslinked or cured with UV radiation.

In addition, the container information can have letters of a predetermined size. Here, a letter center length can be used as a measurement.

According to at least one embodiment, the embossing section is formed and/or arranged and/or positioned at locations on the inner surface of the side part such that the container information on the finished plastic container is at least partially formed with a frosted glass structure on the outer wall of the plastic container.

According to at least one embodiment, after the forming process at least the embossing section is treated at least in places by means of a radiation and/or heating source in order to thus produce a material structure change, in particular wherein the radiation and/or heating source comprises a radiation source, for example a laser source, which impinges on the material of the outer container wall, i.e., on the container information.

According to at least one embodiment, the material structure change is formed by an at least partially crystallized region.

A “material structure change” within the meaning of the present invention can also be, in particular, those areas on the outer surface which, after the actual finishing, i.e., after the actual blowing out of the plastic preforms, have been subjected to a post-treatment in such a way that the material structure changes. This can already be a frosted glass production or a change of a transparency of the wall material or a change of an outer structure, for example a roughness or another post-treatment effect.

In the following, an apparatus for forming plastic preforms into plastic containers is claimed.

All features disclosed for the method described herein are therefore also disclosed for the apparatus described herein and vice versa.

The apparatus described herein for forming plastic preforms into plastic containers has a movable carrier, wherein at least one and preferably a plurality of forming stations for forming the plastic preforms into the plastic containers is arranged on the movable carrier, and these forming stations are moved along a predetermined transport path at least at times during the forming process, wherein the forming stations each have blow mold arrangements, wherein blow mold parts of these blow mold arrangements are moved to open and close the blow mold arrangements, and in a closed state of the blow mold arrangement in a cavity formed by the blow mold parts the plastic preforms can be formed into the plastic containers through the application of a flowable medium.

The apparatus is characterized in that at least one inner surface of the blow mold parts facing the plastic preform has at least one embossing section in the form of at least one raised surface portion and/or one surface depression on the inner surface for forming at least one raised wall portion or at least one wall depression for forming a container information on the finished container, so that the container information is a negative image of the embossing section, in particular so that this embossing section formed as container information replaces an item of label information and the then finished produced container is free of any label, and/or a digital watermark is applied to the finished container, in particular as the container information.

According to at least one embodiment, the embossing section is formed by at least two segment embossing sections adjacent along the inner surface of at least one of the side parts, wherein at least one stiffening region is formed between the segment embossing sections.

The segment embossing sections can therefore each be a single letter or a sequence of letters, for example a lettering. Corresponding stiffening regions in the finished container can be produced, in particular, by forming the inner surface of at least one side part and/or by corresponding other means of the stretch blow molding process assumed as an example.

According to at least one embodiment, the stiffening region of the plastic container is formed by means of at least one raised surface portion and/or a surface depression on the inner surface of at least one side part, wherein this raised portion or depression differ from those which form the container information.

The stiffening region can for example be a material thickening or thinning of the wall thickness of the container, also preferably perceptible haptically by the human hand and/or human finger (wall grooves or planar wall thinning are also possible), which requires more stability for the entire wall structure of the container and at the same time ensures a savings of material.

This is because in principle, stiffening regions are used in a container wall to reduce the remaining wall surface portion or wall volume portion. That is, the remaining points of the container wall are therefore made that much thinner.

In this respect, particularly lightweight containers can be produced which, however, have corresponding wall thickenings in the area of the negative image of the embossing area between the individual lettering elements.

Even assuming that no-label bottles were known in the prior art, these bottles would have a very large so-called “display surface” on which the information is applied. These have the disadvantage that large, spherical, in particular smooth surfaces do not always have the optimal static properties. Thus, such no-label bottles, under pressure load (i.e., top load, burst pressure, thermostability or bottom clearance) have poor stability.

Thus, a core feature of the invention is, among other things, to have a non-continuous display surface that can advantageously intermix with supporting elements (i.e., for example, ribs, material thickenings, and/or grooves with information surfaces). This makes it possible to produce light no-label bottles.

Corresponding stiffening elements can also occur or be arranged in the container wall away from the embossing section, i.e., outside the embossing section. A stiffening region therefore does not necessarily have to pass through an embossing section, for example in the vertical direction (parallel to the longitudinal axis of the container), but can also actually be arranged either on the container wall and/or also on the container bottom and/or in the neck area of the container.

According to at least one embodiment, the stiffening region in the finished plastic container is made in the form of at least one stiffening rib.

In the sense of the present invention, a stiffening rib can be an elongated element which is strip-shaped and forms a wall thickening or wall thinning, compared to the remaining wall thickness of the container, whereby not only a material saving is possible, but the stiffening regions itself are designed to be particularly stiff, so that as few stiffening regions as possible are required on or in the container wall in order to give the container sufficient stability.

### BRIEF DESCRIPTION OF THE DRAWINGS

The patent application described herein is described in more detail below with reference to figures:

FIG. 1 shows a plastic container with stiffening regions;

FIG. 2 shows a prior plastic container without stiffening regions; and

FIG. 3 shows a method for forming preforms into containers in accordance with the instant invention.

### DETAILED DESCRIPTION OF THE DRAWINGS

FIG. 1 shows a plastic container 20 according to the invention claimed here, with four stiffening regions 50 in the form of grooves arranged along the circumference of the container, between each of which a raised inscription 32 is indicated in the longitudinal direction, namely the following words “Water,” “0.5 l,” “Krones,” and “Neutraubling.” Each of the words represents individually or in total the container information described here, which is formed from the material of the side wall of the container 20. The grooves represent individual stiffening regions 50.

In addition, FIG. 1 shows that each stiffening region 50 increases static properties of the plastic container 20, such as a longitudinal axis load (top load) and/or diameter axis load (side load). The plastic container 20 presented here is therefore not only a no-label bottle but also one which is particularly stable under load due to the stiffening regions 50.

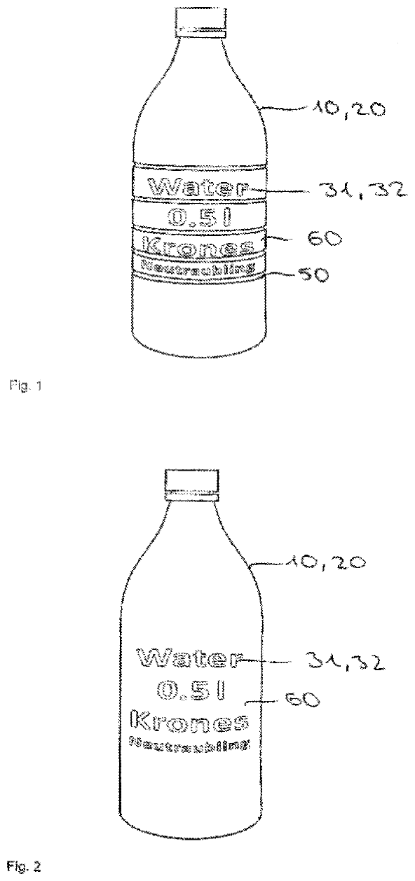

FIG. 2 shows the prior art with a lettering 32 with four words written out along the container wall, wherein between these individual letterings, i.e., words no stiffening regions 50 are arranged. The container 20 of FIG. 2 is not particularly stable under load, in particular when it comes to stacking the container within a pallet.

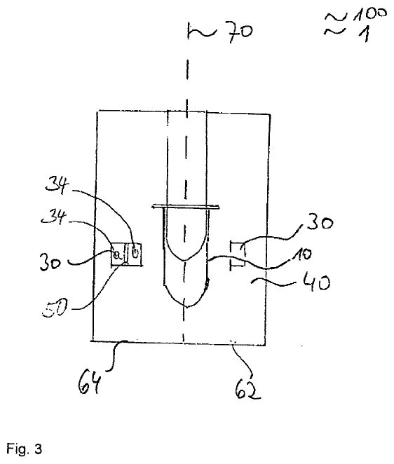

FIG. 3 shows a method 100 for forming plastic preforms 10 into plastic containers 20, wherein at least one and preferably a plurality of forming stations 4 for forming the plastic preforms 10 into the plastic containers 20 are arranged on a movable carrier, and these forming stations 4 are moved along a predetermined transport path at least at times during the forming process, wherein the forming stations 4 each have blow mold arrangements 6, wherein blow mold parts 62, 64 of these blow mold arrangements 6 are moved to open and close the blow mold arrangements 6, and in a closed state of the blow mold arrangement 6 in a cavity formed by the blow mold parts 62, 64 the plastic preforms 10 are formed into the plastic containers 20 by the application of a flowable medium.

FIG. 3 shows that at least one inner surface of the blow mold parts 62, 64 facing the plastic preform 10 has at least one embossing section 30 in the form of at least one raised surface portion and/or one surface depression on the inner surface for forming at least one raised wall portion or at least one wall depression as later container information on the finished container, so that the container information is a negative image 31 of the embossing section 30, and/or a digital watermark is applied to the finished container, in particular as the container information.

FIG. 3 also shows purely schematically that the embossing section 30 has debossed areas and/or embosses areas.

In addition, FIG. 3 shows an apparatus 1 for forming plastic preforms 10 into plastic containers 20, wherein at least one and preferably a plurality of forming stations 4 for forming the plastic preforms 10 into the plastic containers 20 is arranged on a movable carrier, and these forming stations 4 are movable along a predetermined transport path at least at times during the forming process, wherein the forming stations 4 each have blow mold arrangements 6, wherein blow mold parts 62, 64 of these blow mold arrangements 6 are movable to open and close the blow mold arrangements 6, and a closed state of the blow mold arrangement 6 in a cavity formed by the blow mold parts 62, 64 the plastic preforms 10 are formed into the plastic containers 20 by the application of a flowable medium.

Furthermore, it can be seen from FIG. 3 that the embossing section 30 of the apparatus 1 is formed by at least two segment embossing sections 34 adjacent along the inner surface of at least one of the side parts 40, wherein between the segment embossing sections 34 at least one section generating a stiffening region 50, in particular in the form of a change in wall thickness, and the stiffening region 50 of the plastic container 20, is formed by means of at least one raised surface portion and/or a surface depression on the inner surface of at least one side part 40, wherein this raised part or depression being different from those which form the container information, and that the stiffening region 50 is formed in the finished plastic container 20 in the form of at least one stiffening rib.

### LIST OF REFERENCE SIGNS

1 apparatus
4 forming station
6 blow mold arrangement
10 plastic preform
20 plastic container
30 embossing section
31 negative embossing section
32 lettering
34 segment embossing sections
40 side part
50 stiffening region
60 container wall
62 blow mold part
64 blow mold part
70 pivot axis
100 method
201 mouth
202 main body

1. A plastic container with a mouth and a main body, wherein
on an outer surface of the plastic container and/or through the outer surface of the plastic container itself using a wall material and in the form of at least one raised wall portion or at least one wall depression in the form of a wall structure, a container information is attached so that the container information on the finished plastic container replaces an item of label information, wherein the finished produced container is free of a label, and
at least one stiffening region is formed on an outer surface of the plastic container and/or is formed by a wall material of the plastic container itself, wherein the stiffening region defines at least two regions on the outer surface configured to be separated from one another by the at least one stiffening region,
wherein
the wall structures are distributed on at least these two regions.

2. The plastic container according to claim 1,
wherein
a wall thickness of the main body at a location of the largest container diameter is less than 0.15 mm.

3. The plastic container according to claim 1,
wherein
a minimum weight load limit of the filled and closed plastic container along a container longitudinal axis is at least 20 kg.

4. The plastic container according to claim 1,
wherein
the container information is selected from a group of properties and/or information of the container, wherein the group comprises: good readability, minimum lettering size, designation of a food product, net fill quantity, best before date of the filling product, country of origin or place of origin (name of the company or address of the food company), allergy labeling, list of ingredients, quantitative indication of ingredients, storage and use conditions, alcohol content of the filling product, and/or nutritional value declaration.

5. The plastic container according to claim 1,
wherein
the stiffening element increases static properties of the plastic container, such as a longitudinal axial load (top load) and/or diameter axial load (side load).

6. The plastic container according to claim 1,
wherein
the course of the stiffening element also follows force lines in the event of a force load on the plastic container and/or the stiffening element corresponds to or at least partially resembles organic shapes such as ribs in dragonfly wings.

7. The plastic container according to claim 1,
wherein
the plastic container was filled with nitrogen before being closed.

8. A method for forming plastic preforms into plastic containers, wherein at least one forming station for forming the plastic preforms into the plastic containers is arranged on a movable carrier, and this forming station is moved along a predetermined transport path at least at times during the forming process, wherein the forming station has blow mold arrangements, wherein blow mold parts of these blow mold arrangements are moved to open and close the blow mold arrangements, and in a closed state of the blow mold arrangement in a cavity formed by the blow mold parts the plastic preforms are formed into the plastic containers by the application of a flowable medium,
wherein
at least one inner surface of the blow mold parts facing the plastic preform has at least one embossing section in the form of at least one raised surface portion and/or one surface depression for forming at least one raised wall portion or at least one wall depression for forming a container information on the finished container, so that the container information is a negative image of the embossing section, and/or a digital watermark is applied to the finished container.

9. The method according to claim 8,
wherein
the container information on the finished plastic container replaces an item of label information, and in that the finished produced container is free of a label.

10. The method according to claim 8,
wherein
during the forming process, the expanding plastic container is pressed against this inner surface by the flowable medium so that, as a result of this application of pressure, the embossing section leaves the container information on the outer surface of the plastic container as a negative image.

11. The method according to claim 8,
wherein
the embossing section has debossed areas and/or embossed areas.

12. The method according to claim 11,
wherein
the embossing section is formed and/or arranged and/or positioned at locations on the inner surface of the side part such that the container information on the finished plastic container is at least partially formed with a frosted glass structure within the outer wall of the plastic container.

13. The method according to claim 11,
wherein
after the forming process at least the embossing section is treated at least in places using a radiation and/or heating source in order to thus produce a material structure change, wherein the radiation and/or heating source comprises a radiation source, for example a laser source, configured to impinge on the material of the outer container wall, i.e., on the container information.

14. The method according to claim 13,
wherein
the material structure change is formed by an at least partially crystallized region.

15. An apparatus for forming plastic preforms into plastic containers, wherein at least one forming station for forming the plastic preforms into the plastic containers is arranged on a movable carrier, and this forming station is movable along a predetermined transport path at least at times during the forming process, wherein the forming station(s) each have blow mold arrangements, wherein the blow mold parts of these blow mold arrangements are movable to open and close the blow mold arrangements, and in a closed state of the blow mold arrangement in a cavity formed by the blow mold parts the plastic preforms are formable into the plastic containers by the application of a flowable medium
wherein
at least one inner surface of the blow mold parts facing the plastic preform has at least one embossing section in the form of at least one raised surface portion and/or one surface depression on the inner surface for forming at least one raised wall portion or at least one wall depression for forming a container information on the finished container, so that the container information is a negative image of the embossing section, so that this embossing section formed as container information replaces a label information and the then finished produced container is free of a label, and/or there is a digital watermark onto the finished container.

16. The apparatus according to claim 15,
wherein
the embossing section is formed by at least two segment embossing sections adjacent along the inner surface of at least one of the side parts, wherein at least one section generating a stiffening region, for example in the form of a circumferential groove, is arranged between the segment embossing sections.

17. The apparatus according to claim 16,
wherein
the stiffening region of the plastic container is formed by at least one raised surface portion and/or a surface depression on the inner surface of at least one side part, wherein this raised part or depression differ from those configured to form the container information.

18. The apparatus according to claim 15,
wherein
the stiffening region in the finished plastic container is made in the form of at least one stiffening rib.

19. The method according to claim 9,
wherein
during the forming process, the expanding plastic container is pressed against this inner surface by the flowable medium so that, as a result of this application of pressure, the embossing section leaves the container information on the outer surface of the plastic container as a negative image.
